(19) United States
(12) Patent Application Publication
(10) Pub. No.: US 2010/0109855 A1
(43) Pub. Date: May 6, 2010

(54) SOUNDER CONTROL CIRCUIT, SOUNDER SYSTEM AND METHOD FOR VEHICLE

(75) Inventors: Jung-Huang Liao, Hsinchu County (TW); Chih-Wei Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/346,838

(22) Filed: Dec. 31, 2008

(30) Foreign Application Priority Data
Nov. 5, 2008 (TW) 97142741

(51) Int. Cl. B60Q 1/00

(52) U.S. Cl. 340/425.5

(57) ABSTRACT

A sounder control circuit is applicable to for a vehicle with a plurality of sounders, in which each sounder is used for generating a sound signal toward a different direction respectively. The sounder control circuit includes a switch module, a control module and a driving module. The switch module has a plurality of switches, and outputs an operation signal to the control module according to a status of each of the switches. Thus, the control module outputs a control signal to the driving module according to the operation signal for driving at least one of the sounders to output the sound signal.

### CROSS-REFERENCE TO RELATED APPLICATION

This application claims the priority benefit of Taiwan application serial no. 97142741, filed on Nov. 5, 2008. The entirety of the above-mentioned patent application is hereby incorporated by reference herein and made a part of specification.

### BACKGROUND OF THE INVENTION

1. Field of the Invention

The present invention generally relates to a sounder system of an alarming sound, in particular, to a sounder system of an alarming sound for a vehicle.

2. Description of Related Art

The first automobile came to the world in Germany in 1886. However, it was until 1900 that America began to put the automobiles into a mass production. Up to now, the development history of automobiles is nearly one hundred years, in which breakthroughs and development have been achieved in the fields of safety, comfort, convenience, and even environmental protection and energy saving concerned by the public. Further, more and more high technologies are implemented in a new generation of automobiles in combination with applied technology, such as the technology of automobile navigation or mobile theatre, so that the operation and control of the automobiles is more human-oriented.

However, during the long development history of the automobiles, no significant improvement or breakthrough is achieved in the design of a loudspeaker system for external alarming. FIG. 1 is a circuit block diagram of a conventional automobile loudspeaker system. Referring to FIG. 1, generally, a switch 104 of an automobile loudspeaker 102 is arranged on a steering wheel 106 of the automobile. When the switch 104 is pressed by a user, the switch 104 is turned on, so that a loop is formed by a battery 108 and the loudspeaker 102. Thus, the loudspeaker 102 is driven to give out a sound.

It is known that, when the loudspeaker is driven to sound, an alarming sound generated by the loudspeaker is toward all directions, which often causes misunderstanding of other automobile drivers because the alarming sound that should otherwise be generated toward only the objects in a certain direction is heard by others in other directions. Also, the sound wave is propagated in all directions, so when the driver desires to generate the alarming sound toward only a certain direction, the surrounding environment may be influenced by the alarming sound at the same time. Such influence is most obvious on the important roads, seriously affecting the life quality of the households near the roads.

### SUMMARY OF THE INVENTION

Accordingly, the present invention is directed to a sounder control circuit for controlling a sounder on a vehicle.

The present invention is also directed to a sounder system and method for a vehicle for enabling a vehicle to generate an alarming sound toward a predetermined direction.

A sounder control circuit is provided in the present invention. The sounder control circuit is applicable to a vehicle with a plurality of sounders, in which each sounder is used for generating a sound signal toward a different direction. The sounder control circuit of the present invention includes a switch module, a control module, and a driving module. The switch module has a plurality of switches, and outputs an operation signal to the control module according to a status of the switches. Thus, the control module may output a control signal to the driving module according to the operation signal, for driving at least one of the sounders to output the sound signal.

In another aspect, a sounder system for a vehicle is provided in the present invention. The sounder system includes a sounder module, an operation panel, and a control circuit. The sounder module has at least a sounder for outputting a sound signal. The operation panel has a plurality of operating units, and is coupled to the control circuit. When one of the operating units is enabled, the control circuit may drive the sounder to output the sound signal, so that the vehicle generates an alarming sound toward a direction corresponding to the enabled operating unit.

In another aspect, a sounder method for a vehicle is further provided in the present invention. The sounder method includes providing a plurality of operating units, and generating an alarming sound directionally toward a direction corresponding to an enabled operating unit when one of the operating units is enabled.

Only when an operating unit is enabled, the present invention may directionally generate the alarming sound toward a direction corresponding to the enabled operating unit. Thus, the present invention would generate the alarming sound without influencing irrelevant targets, and enables targets that a driver desires to alarm to receive such a message accurately.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of a conventional automobile loudspeaker system.

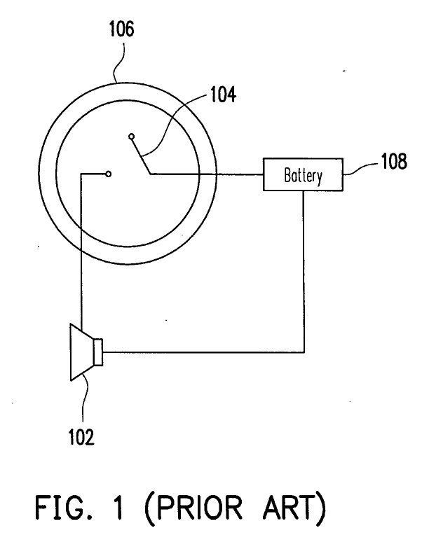

FIG. 2 is a system block diagram of a sounder system according to a preferred embodiment of the present invention.

FIG. 3 is a schematic view of an operation panel according to a preferred embodiment of the present invention.

FIG. 4 is a circuit diagram of a control circuit and a sounder module according to a first embodiment of the present invention.

FIG. 5 is a schematic configuration diagram of a sounder according to the first embodiment of the present invention.

FIG. 6 is a cross-sectional view of a soundproof shield according to a preferred embodiment of the present invention.

FIG. 7 is a system block diagram of a sounder system according to a second embodiment of the present invention.

FIG. 8 is a system block diagram of a sensing module and a control module according to a preferred embodiment of the present invention.

FIG. 9 is a system block diagram of a sounder system according to a third embodiment of the present invention.

FIG. 10 is a system block diagram of a sounder system according to a fourth embodiment of the present invention.

FIG. 11 is a schematic configuration diagram of a sounder according to the fourth embodiment of the present invention.

FIG. 12 is a waveform diagram of ultrasonic beams at an intersection point.

FIG. 13 is a schematic view of an operation panel according to another embodiment of the present invention.

FIG. 14 is a system block diagram of a sounder system according to a fifth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

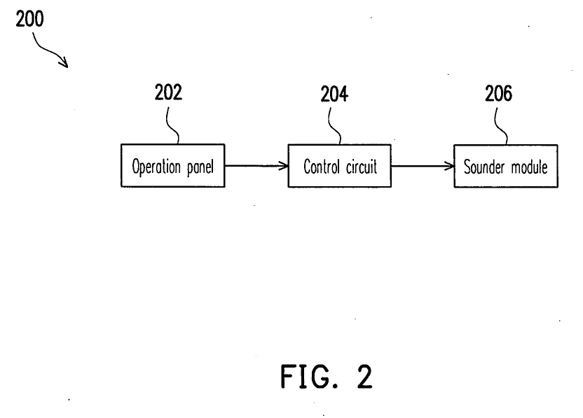

FIG. 2 is a system block diagram of a sounder system according to a preferred embodiment of the present invention. Referring to FIG. 2, the sounder system 200 provided in this embodiment may be applied in a vehicle such as an automobile. The sounder system 200 includes an operation panel 202, a control circuit 204, and a sounder module 206. The operation panel 202 may be coupled to the control circuit 204, and the control circuit 204 may be coupled to the sounder module 206.

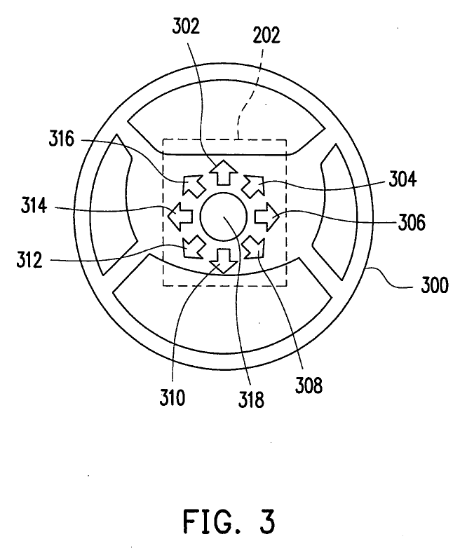

FIG. 3 is a schematic view of an operation panel according to a preferred embodiment of the present invention. Referring to FIGS. 2 and 3 together, the operation panel 202 may be disposed on a steering wheel 300 of the vehicle, and the operation panel 202 may further include a plurality of operating units 302, 304, 306, 308, 310, 312, 314, 316, and 318 operated by a user. When one of the operating units is pressed by a vehicle driver, the control circuit 204 may drive the sounder module 206 according to the pressed operating unit, so that the vehicle may generate an alarming sound directionally toward a direction corresponding to the pressed operating unit.

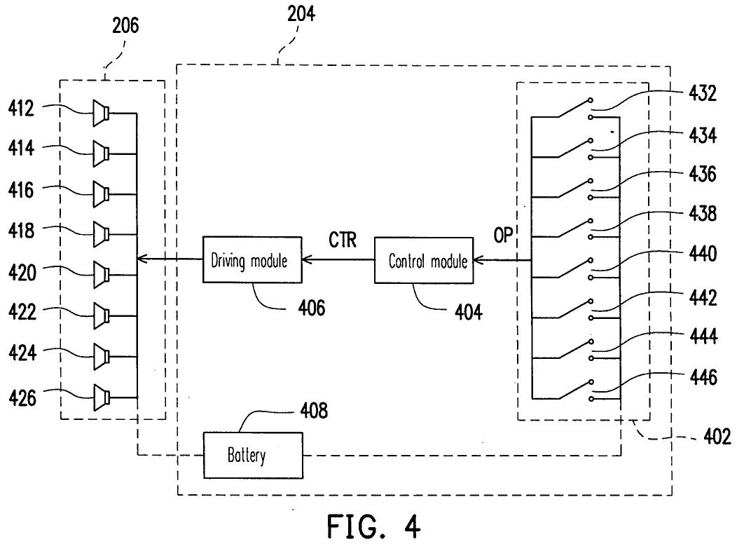

FIG. 4 is a circuit diagram of a control circuit and a sounder module according to a first embodiment of the present invention. Referring to FIG. 4, in the first embodiment, the control circuit 204 includes a switch module 402, a control module 404, a driving module 406, and a battery 408. The switch module 402 may be coupled to the control module 404 and the battery 408, and the control module 404 may be coupled to the driving module 406. Furthermore, the driving module 406 may be coupled to the sounder module 206.

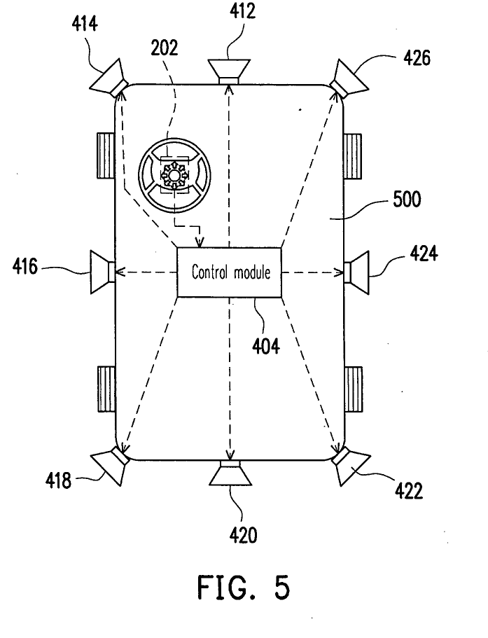

The sounder module 206 may be coupled to the battery 408, and includes a plurality of sounders 412, 414, 416, 418, 420, 422, 424, and 426. These sounders are, for example, loudspeakers, which may be arranged on a shell of the vehicle, as shown in FIG. 5. Referring to FIG. 5 together, in this embodiment, the vehicle may be an automobile 500, and each sounder 412, 414, 416, 418, 420, 422, 424, and 426 may be arranged on the shell of the automobile 500, and may generate a sound signal toward a different direction, respectively. For example, the sounders 412, 414, 416, 418, 420, 422, 424, and 426 may generate the sound signal toward the front, left front, left, left rear, rear, right rear, right, and right front of the automobile 500 respectively. In this embodiment, the frequency of the sound signals generated by the sounders may be between 20 Hz and 20 KHz.

Referring to FIG. 4 again, the switch module 402 also includes a plurality of switches 432, 434, 436, 438, 440, 442, 444, and 446 corresponding to the sounders 412, 414, 416, 418, 420, 422, 424, and 426, respectively, and may be coupled to the operating units 302, 304, 306, 308, 310, 312, 314, 316, 318 on the operation panel 202 in FIG. 3 respectively and to the control module 404. Thus, when one of the operating units (for example, the operating unit 302) on the operation panel 202 is pressed, a corresponding switch (for example, the switch 432) would be turned on. At this time, the switch module 402 may output an operation signal OP to the control module 404, and the control module 404 may generate a control signal CTR for the driving module 406 according to the operation signal OP. Thus, the driving module 406 may drive a corresponding sounder (for example, the sounder 412) to sound.

In this embodiment, an operating unit (for example, the operating unit 318) may also be set to a button for driving all the sounder 412, 414, 416, 418, 420, 422, 424, and 426. Assuming that when the operating unit 318 is pressed, the control module 404 may control the driving module 406 to drive all the sounders 412, 414, 416, 418, 420, 422, 424, and 426 to produce a sound signal synchronously for generating an alarming sound. In other words, when the operating unit 318 is pressed, an alarming sound would be generated toward all directions as in a traditional automobile.

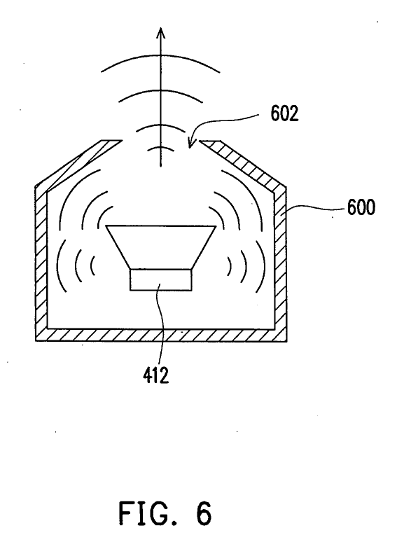

To enable the sounders 412, 414, 416, 418, 420, 422, 424, and 426 to sound toward their respective directions accurately, in this embodiment, each sounder may be installed within a soundproof shield. FIG. 6 shows a sectional view of a soundproof shield according to a preferred embodiment of the present invention. Referring to FIG. 6, just as its name implies, the soundproof shield 600 in this embodiment is made of a soundproof material, and has an opening 602. When a sounder (for example, the sounder 412) generates a sound signal, the sound wave passing through the opening 602 may be propagated out to form the alarming sound, while the sound waves in other directions may be blocked by the soundproof shield 600. Therefore, the embodiment may achieve the objective of directionally generating the alarming sound.

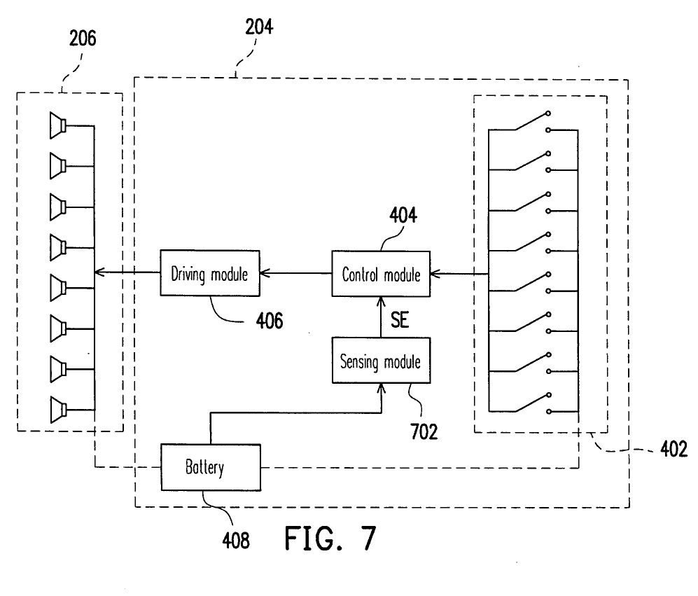

FIG. 7 shows a system block diagram of a sounder system according to a second embodiment of the present invention. Referring to FIG. 7, the quality of the alarming sound generated by the sounder module 206 may be influenced by the characteristic parameters of the vehicle or the environmental parameters surrounding the vehicle. Thus, in this embodiment, a sensing module 702 may also be arranged in the control circuit 204 to detect these parameters. After the sensing module 702 detects these parameters, a sense signal SE may be output to the control module 404. Therefore, the sensing module 404 may control the driving module 406 to drive the sounder module 206 with reference to the sense signal SE, so as to maintain the quality of the alarming sound.

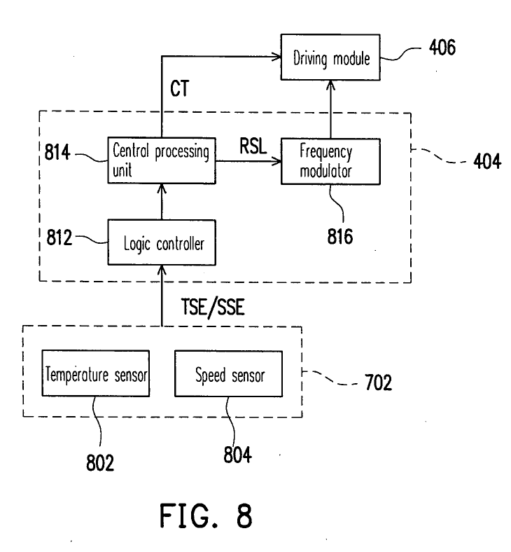

FIG. 8 is a system block diagram of a sensing module and a control module according to a preferred embodiment of the present invention. Referring to FIG. 8, in this embodiment, the sensing module 702 may include a temperature sensor 802 and a speed sensor 804. The temperature sensor 802 may sense a temperature of the surrounding environment of the vehicle, and the speed sensor 804 may sense a current speed of the vehicle. After the temperature sensor 802 senses the temperature of the surrounding environment, a temperature sense signal TSE may be output to the control module 404. Correspondingly, after the speed sensor 804 senses the current speed of the vehicle, a speed sense signal SSE may be output to the control module 404.

The control module 404 may include a logic controller 812, a central processing unit 814, and a frequency modulator 816. The logic controller 812 may be coupled to the sensing module 702, and coupled to the central processing unit 814. Furthermore, the central processing unit 814 may be coupled to the frequency modulator 816 and the driving module 406. The logic controller 812 may receive the sense signals SE, such as the temperature sense signal TSE and/or the speed sense signal SSE, from the sensing module, and send the sense signals SE to the central processing unit 814. After the central processing unit 814 receives the output of the logic controller 812, a computation may be performed on the sense signals to generate an operation result RSL for the frequency modulator 816. Thus, the frequency modulator 816 may control the driving module 406 according to the operation result RSL, to modulate a frequency of the sound signals generated by the sounder module 206.

Furthermore, the above embodiments may be extended for application. Persons of ordinary skill in the art can understand that another volume operating unit may also be arranged on, for example, the panel 202 in FIG. 2, to adjust a volume of the sound signals generated by the sounder module 206.

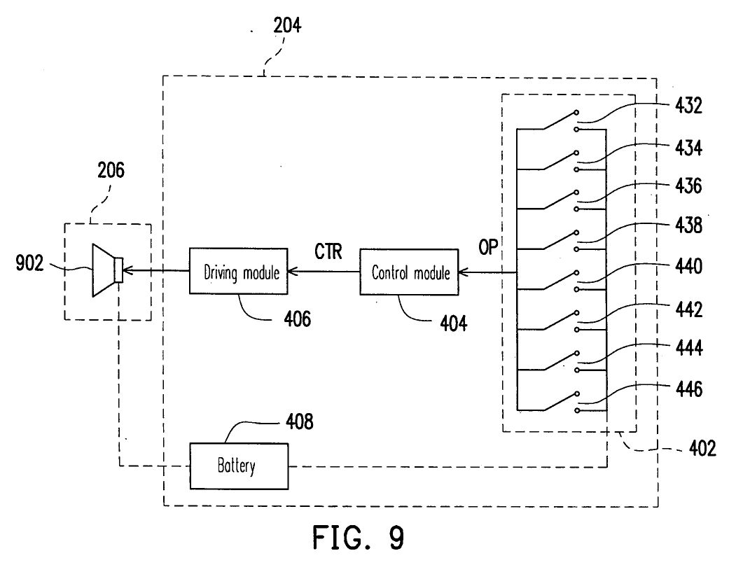

FIG. 9 is a system block diagram of a sounder system according to a third embodiment of the present invention. Referring to FIG. 9, in this embodiment, the sounder module 206 may also be implemented as a single sounder 902. When one of the operating units in FIG. 3 is pressed by the driver, the control module 404 may control the driving module 406 to make the sounder module 206 turn to a direction corresponding to the pressed operating unit, and make the sounder 902 generate the sound signal toward the direction. Therefore, in this embodiment, the sounder module 206 may be installed on the top of the vehicle to generate the sound signal toward every direction.

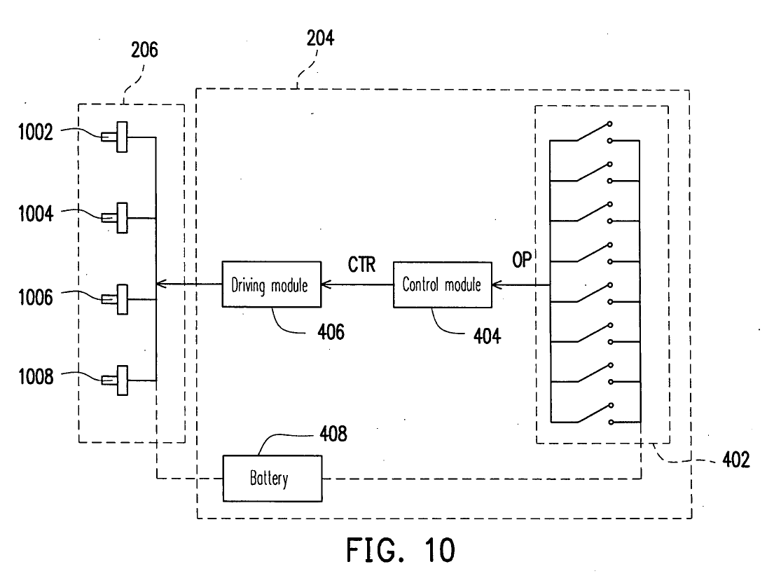

FIG. 10 is a system block diagram of a sounder system according to a fourth embodiment of the present invention. Referring to FIG. 10, in this embodiment, the sounders in the sounder module 206 may be implemented as multidirectional ultrasonic transmitters, e.g., 1002, 1004, 1006, and 1008. The multidirectional ultrasonic transmitters may transmit ultrasonic beams toward multiple directions, and the phases and/or waveforms of the ultrasonic beams may be different.

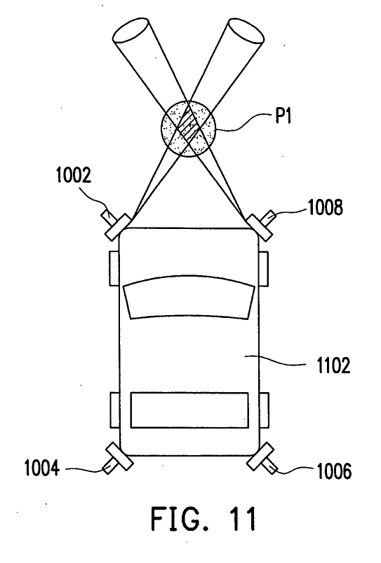

FIG. 11 is a schematic configuration diagram of a sounder according to the third embodiment of the present invention. Referring to FIGS. 10 and 11 together, the ultrasonic transmitters in this embodiment may generate the ultrasonic beams toward three directions, but the present invention is not limited to be so. When the driver of the vehicle 1102 desires to generate the alarming sound toward the front, the operating unit 302 in FIG. 3 may be pressed as well. At this time, the switch module 402 may output the operation signal OP to the control module 404, and make the control module 404 output the corresponding control signal CTR to the driving module 406. Thus, the driving module 406 may control a part of the ultrasonic transmitters, e.g., 1002 and 1008, to transmit the ultrasonic beams toward an intersection point P1 at the external of the vehicle 1102 together.

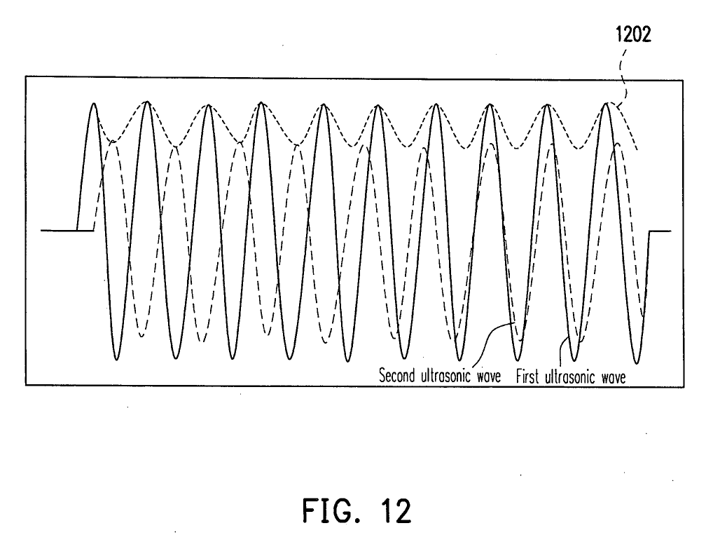

FIG. 12 is a waveform diagram of the ultrasonic beams at the intersection point. Referring to FIG. 12, the phases and/or waveforms of the ultrasonic beams transmitted by each ultrasonic transmitter 1002, 1004, 1006, and 1008 are different, so when a plurality of ultrasonic transmitters generates the ultrasonic beams toward the intersection point together, the ultrasonic beams would interfere with each other at the intersection point to generate a harmonic wave 1202. The frequency of the harmonic wave is in a range which may be heard by human ears, so an alarming sound may be generated. In this embodiment, the frequency of the ultrasonic beams generated by the ultrasonic transmitters 1002, 1004, 1006, and 1008 may be, for example, between 250 KHz to 25 MHz.

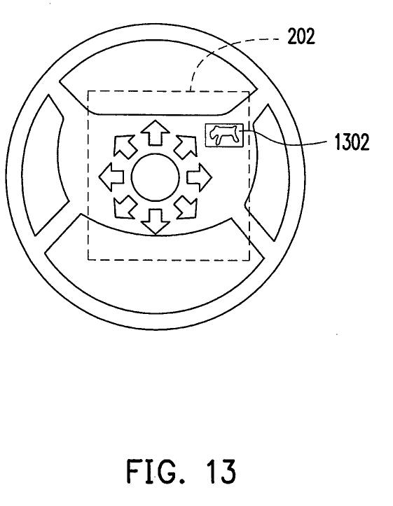

Furthermore, this embodiment may be extended for application. The automobile driver may often encounter some traffic situation, e.g., may come across an animal, such as a dog, a cat and the like, in the front in driving, which may cause an incident and seriously influence the driving safety. The cat may hear a frequency of 250 KHz, and the dog may hear a frequency of 350 KHz. Therefore, the driver may utilize the ultrasonic beams at above frequencies transmitted by the ultrasonic transmitters in this embodiment to expel the cat, the dog, and other animals, so as to guarantee the life of these animals and guarantee the driving safety of the driver. Among others, the present invention further provides an embodiment of an operation panel, as shown in FIG. 13. Referring to FIG. 13, in this embodiment, a hot key 1302 may be arranged on the operation panel 202. When the hot key 1302 is pressed by the driver, the frequency modulator 816 in FIG. 8 makes the ultrasonic transmitters generate a sound signal that can be heard by cat ears or dog ears, thereby expelling the animals that may the driving safety. This embodiment may also be applied in an aeroplane for expelling birds.

Besides, the sounder system in FIG. 10 generates the alarming sound by utilizing the interference between the ultrasonic beams. Thus, in these embodiments, a distance between the intersection point and the vehicle may be adjusted by merely adjusting an angle for transmitting the ultrasonic beams. In other words, according to this embodiment, the alarming sound may be generated at a closer or farther distance.

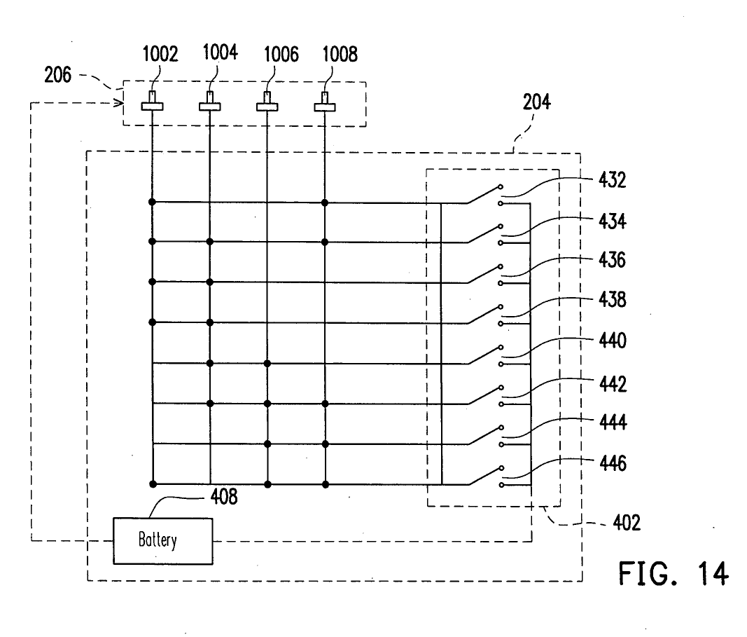

FIG. 14 is a system block diagram of a sounder system according to a fifth embodiment of the present invention. Referring to FIG. 14, in this embodiment, the control circuit 204 may be accomplished by wiring, so no complicated control is needed.

To sum up, the present invention has some advantages, for example, the present invention can accurately alarm the objects desired by the driver without influencing the peace of the environment or causing a misunderstanding, because the present invention may generate the alarming sound directionally toward a direction. Furthermore, the present invention may use the ultrasonic transmitters as the sounders, so the present invention may also expel the animals impairing the traffic to ensure the driving safety.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sounder control circuit, applicable to a vehicle with a plurality of sounders, wherein each of the sounders is used for generating a sound signal toward a different direction, the sounder control circuit comprising:
a switch module, comprising a plurality of switches, and outputting an operation signal according to a status of the switches;
a control module, coupled to the switch module, and outputting a control signal according to the operation signal; and
a driving module, coupled to the control module, and driving at least one of the sounders to output the sound signal according to the control signal.

2. The sounder control circuit according to claim 1, wherein the driving module further controls at least one of the sounders to output the sound signal toward a specific direction according to the control signal.

3. The sounder control circuit according to claim 1, wherein a number of the switches is greater than a number of the sounders.

4. The sounder control circuit according to claim 1, further comprising a sensing module coupled to the control module, for sensing a characteristic parameter of the vehicle or an environmental parameter surrounding the vehicle, and outputting a sense signal to the control module.

5. The sounder control circuit according to claim 4, wherein the sensing module comprises:
a temperature sensor, for sensing a temperature of a surrounding environment of the vehicle, and outputting a temperature sense signal to the control unit; and
a speed sensor, for sensing a speed of the vehicle, and outputting a speed sense signal to the control unit.

6. The sounder control circuit according to claim 4, wherein the control module comprises:
a logic controller, coupled to the sensing module, for receiving the sense signal, and generating a logic output; and
a central processing unit, coupled to the logic controller, for generating the control signal according to the logic output.

7. The sounder control circuit according to claim 6, wherein the control module further comprises a frequency modulator coupled to the central processing unit, for generating a frequency modulation signal for the driving module according to an output of the central processing unit, so as to determine a frequency of the sound signal output by each of the sounders.

8. A sounder system for a vehicle, comprising:
a sounder module, comprising at least one sounder, for outputting a sound signal;
an operation panel, comprising a plurality of operating units; and
a control circuit, coupled to the sounder module and the operation panel, for driving the sounder to output the sound signal when at least one of the operating units is enabled, so that the vehicle generates an alarming sound toward a direction corresponding to the enabled operating unit.

9. The sounder system according to claim 8, wherein the operation panel is arranged on a steering wheel of the vehicle.

10. The sounder system according to claim 8, wherein the sounder module further comprises a plurality of sounders, and each of the sounders is used for outputting the sound signal toward a different direction.

11. The sounder system according to claim 10, wherein the sounder module further comprises a plurality of soundproof shields, so that each of the sounders is arranged in one of the soundproof shields correspondingly, and each of the soundproof shields has an opening, so that when one of the sounders outputs the sound signal, the sound signal is propagated out through the opening.

12. The sounder system according to claim 10, wherein the control circuit comprises a switch module with a plurality of switches, and the switches are coupled to the sounders and the operating units correspondingly to drive at least one of the sounders to output the sound signal when one of the operating units is enabled, so that the vehicle generates the alarming sound toward a direction corresponding to the enabled operating unit.

13. The sounder system according to claim 10, wherein the sound signal generated by each of the sounders is an ultrasonic beam at a different phase.

14. The sounder system according to claim 13, wherein when one of the operating units is enabled, a part of the sounders generate corresponding ultrasonic beams toward an intersection point at an external of the vehicle, so that the ultrasonic beams interfere with each other at the intersection point to generate the alarming sound.

15. The sounder system according to claim 10, wherein the control circuit further comprises:
a switch module, comprising a plurality of switches coupled to the operating units respectively, for generating an operation signal when one of the operating units is enabled;
a control module, coupled to the switch module, for outputting a control signal according to the operation signal; and
a driving module, coupled to the control module, for driving the corresponding sounder to output the sound signal according to the control signal.

16. The sounder system according to claim 8, wherein the control circuit comprises:
a switch module, comprising a plurality of switches coupled to the operating units respectively, for generating an operation signal when one of the operating units is enabled;
a control module, coupled to the switch module, for outputting a control signal according to the operation signal; and
a driving module, coupled to the control module, for turning the sounder according to the control signal to generate the sound signal toward a direction corresponding to the enabled operating unit.

17. The sounder system according to claim 8, wherein a frequency of the sound signal is between 20 Hz to 20 KHz.

18. The sounder system according to claim 8, wherein a frequency of the sound signal is between 250 KHz to 25 MHz.

19. The sounder system according to claim 8, wherein the operation panel further comprises a volume control unit for controlling a volume of the sound signal.

20. A sounder method for a vehicle, comprising:
providing a plurality of operating units; and
generating an alarming sound directionally toward a direction corresponding to an enabled operating unit when one of the operating units is enabled.

21. The sounder method according to claim 20, wherein the step of generating the alarming sound comprises:
generating a plurality of ultrasonic beams at different phases; and
directing travelling paths of the ultrasonic beams toward an intersection point at an external of the vehicle, so that the ultrasonic beams interfere with each other at the intersection point to generate the alarming sound.
